(19) United States
(12) Patent Application Publication
(10) Pub. No.: US 2012/0324495 A1
(43) Pub. Date: Dec. 20, 2012

(54) DETECTING AND DISTRIBUTING VIDEO CONTENT IDENTITIES

(75) Inventors: Joseph H. Matthews, III, Woodinville, WA (US); James A. Baldwin, Palo Alto, CA (US); David Rogers Treadwell, III, Seattle, WA (US)

(73) Assignee: MICROSOFT CORPORATION, Redmond, WA (US)

(21) Appl. No.: 13/163,508

(22) Filed: Jun. 17, 2011

(51) Int. Cl. H04H 60/32

(52) U.S. Cl. 725/14

(57) ABSTRACT

Embodiments related to distributing an identity of a video item being presented on a video presentation device within a video viewing environment to applications configured to obtain content related to the video item are disclosed. In one example embodiment, an identity is transmitted by determining an identity of the video item currently being presented on the video presentation device and responsive to a trigger, transmitting the identity of the video item to a receiving application while the video item is being presented on the video presentation device.

### BACKGROUND

It is increasingly common for television viewers to watch a show while using a computing device. Frequently, viewers search the Internet for content related to the show to extend the entertainment experience. In view of the vast amount of information available on the Internet, it can be difficult for the viewer to find content specifically related to the television show the viewer is watching at a particular instant. Further, because the viewer's attention may be distracted from the show while searching for relevant content, the viewer may miss exciting developments in the television show, potentially spoiling the viewer's entertainment experience.

### SUMMARY

Embodiments related to distributing an identity of a video item being presented on a video presentation device within a video viewing environment to applications configured to obtain content related to the video itemare provided. In one example embodiment, an alert is provided by determining an identity of the video item currently being presented on the video presentation device, and, responsive to a trigger, transmitting the identity of the video item while the video item is being presented on the video presentation device. The identity may then be received by a receiving device and used to obtain supplemental content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a viewer watching a video item in a video viewing environment according to an embodiment of the present disclosure.

FIGS. 2A-B show a flow chart depicting a method of distributing an identity of a video item to applications configured to obtain content related to the video item according to an embodiment of the present disclosure.

FIG. 3 schematically shows a computing device according to an embodiment of the present disclosure.

### DETAILED DESCRIPTION

Viewers may enjoy viewing supplementary content (like web content) that is contextually related to video content while the video content is being watched. For example, a viewer may enjoy finding trivia for an actor while watching a movie, sports statistics for a team while watching a game, and character information for a television series while watching an episode of that series. However, the act of searching for such content may distract the viewer, who may miss out on part of the video content due to having to manually enter search terms and sort through search results, or otherwise manually navigate to content.

Thus, the disclosed embodiments relate to facilitating the retrieval and presentation of such supplemental information by transmitting an identity of a video item being presented on a device in a viewing environment to one or more applications configured to present such supplemental information. The identity of the video content item and/or a particular scene or other portion of the video content item may be determined and transmitted by an identity transmission service to a receiving application registered with the identity transmission service. Upon receipt of the identity, the receiving application may fetch related content and present it to the viewer. Thus, the viewer is presented with potentially interesting related content with a potentially lower search burden. It will be understood that, in various embodiments, the receiving application may be on a different device or same device as the identity transmission service.

The identity of the video content item may be determined in any suitable manner. For example, in some situations, an identifier may be included with a video item upon creation of the video item in the form of metadata that contains identity information in some format recognizable by the identity transmission service. As a more specific example, a television network that broadcasts a series over cable, satellite, or other television transmission medium may include metadata with the transmission that is readable by a set-top box, an application running on a media presentation computer, or other media presentation device, to determine an identification of the broadcast. The format of such metadata may be proprietary, or may be an agreed-upon format utilized by multiple unrelated entities.

The identity information may include any suitable information about the associated video item. For example, the identity information may identify particular scenes within the video item, in addition to the video content item as a whole. As a more specific example, a particular scene may include actors and/or objects specific to that scene that may not appear in other portions of the video content item. Therefore, the transmission of such identity information may allow a device that receives the identity information to fetch information related to that particular scene while the scene is playing.

In other cases, a video content item may lack such identification metadata. For example, as a television program is syndicated, adapted into different languages, adapted for different formats (broadcast as opposed to streaming, for example), the media content item may be edited. Such editing may involve shortening the content by removing frames from the content. Such frames may be located at opening or closing credits, or even within the content itself. Thus, any identification metadata that is associated with a particular scene in the video content may be lost if such edits are made. Furthermore, at times, a clip of a video content item may be presented separately from the rest of the video content item.

In light of such issues, and considering the proliferation of video clips on the Internet, a snippet taken from a longer video item may be extremely difficult to identify in an automated fashion once set adrift from its identifier. As a consequence, an application seeking to automatically obtain supplemental content related to a video item being viewed may not be able to identify the video item in many situations. Indeed, a viewer, much less an automated identification transmission service, may have a difficult time identifying such clips.

To overcome such difficulties, in some embodiments, video fingerprinting technologies may be used to detect the identity of a portion of a video item and build a digital fingerprint for that video item. Later, the digital fingerprint may be detected, identified, and an alert may be transmitted to the application so that the application may obtain related content. The “fingerprint” of a video item may be identified based on patterns detected in one or more of a video signal and/or an audio signal for the video item. For example, color and/or motion tracking techniques may be used to identify variations between selected frames in the video signal and the result of such tracking may provide an extracted video fingerprint, either for an overall video item or for a specific scene in the video item (such that multiple scenes are fingerprinted). A similar approach may be used for an audio signal. For example, audio features (e.g., sound frequency, intensity, and duration) may be tracked, providing an extracted audio fingerprint. In other words, fingerprinting techniques extract perceptible characteristics of the video item (like the visual and/or audible characteristics that human viewers and listeners use to identify such items) when building a digital fingerprint for a video item. Consequently, fingerprinting techniques may overcome potential variations in a video and/or audio signal resulting from video items that may have been modified during editing (e.g., from compression, rotation, cropping, frame reversal, insertion of new elements, etc.). Given the ability to potentially identify video items despite such alterations, a viewer encountering an unknown video item may still discover supplementary content related to the video item and/or scenes in a video item, potentially enriching the viewer's entertainment experience.

Once constructed, the digital fingerprints may be stored in database so that the digital fingerprint may be accessed for identification in response to a request to identify a particular video item in real time. Further, in some embodiments, such a database may be used as a clearinghouse for licensing rights to enable the tracking of reproduction and/or presentation of video content items virtually independent of the format into which the video item may eventually be recorded.

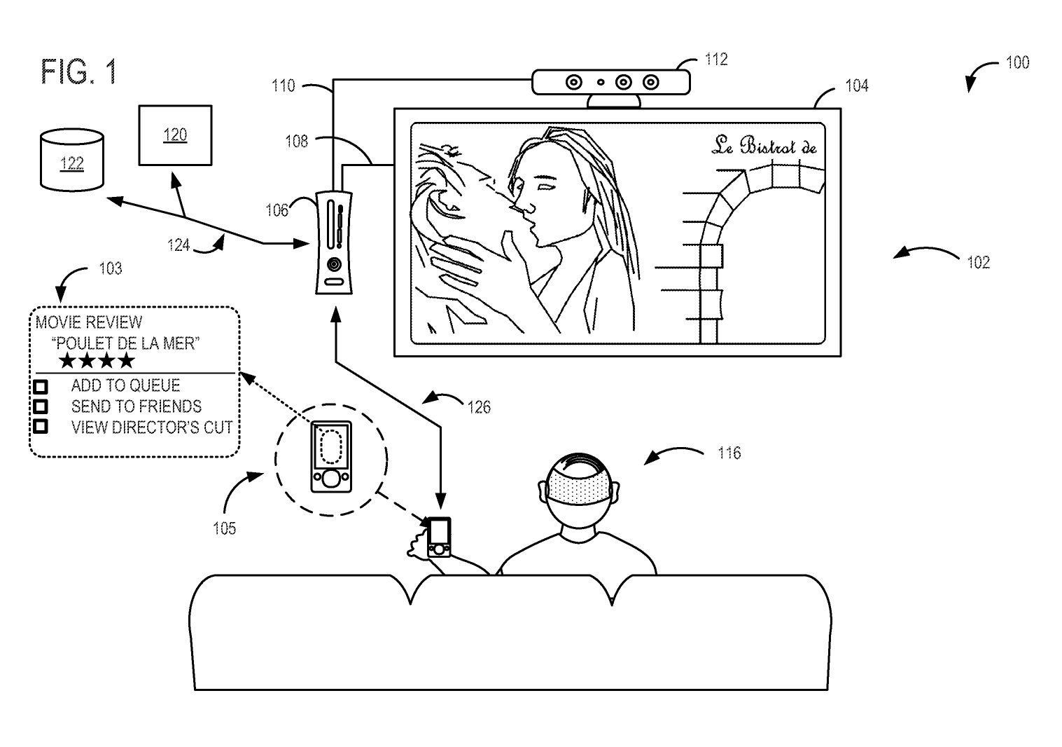

FIG. 1 schematically shows an embodiment of a video viewing environment 100 in which video item 102 is displayed on video presentation device 104 and in which supplementary content 103 may be displayed on mobile computing device 105. Display of video item 102 may be controlled by computing devices, such as media computing device 106, or may be controlled in any other suitable manner. The media computing device 106 may comprise a game console, a set-top box, a desktop computer, laptop computer, notepad computer, or any other suitable computing device. Media computing device 106 may include various outputs (such as output 108) configured to output video and/or audio to video presentation device 104 and/or to an audio presentation device, respectively. Media computing device 106 may also include one or more inputs 110 configured to receive input from a video viewing environment sensor system 112 and/or other suitable inputs (for example, video input devices such as DVRs, DVD players, etc.).

Video viewing environment sensor system 112 provides sensor data collected from video viewing environment 100 to media computing device 106. Video viewing environment sensor system 112 may include any suitable sensors, including but not limited to one or more image sensors, depth sensors, and/or microphones or other acoustic sensors. Further, in some embodiments, sensors that reside in other devices than video viewing environment sensor system 112 may be used to provide input to media computing device 106. For example, in some embodiments, an acoustical sensor included in a mobile computing device 105 (e.g., a mobile phone, a laptop computer, a tablet computer, etc.) held by viewer 116 within video viewing environment 100 may collect and provide sensor data to media computing device 106. It will be appreciated that the various sensor inputs described herein are optional, and that some of the methods and processes described herein may be performed in the absence of such sensors and sensor data.

In the example shown in FIG. 1, media computing device 106 obtains the video identity for video item 102 and distributes it to a receiving application running on mobile computing device 105. In turn, mobile computing device 105 retrieves supplementary content 118 contextually-related to video item 102 and presents it to viewer 116. It will be appreciated that the various devices shown in FIG. 1 are not limited to being related devices and running related services. That is, devices from various manufacturers, running different services, may interoperate to perform the processes described herein. Further, as described below, identity information may be provided by an identity transmission service to an application running on the same computing device as the identity transmission service.

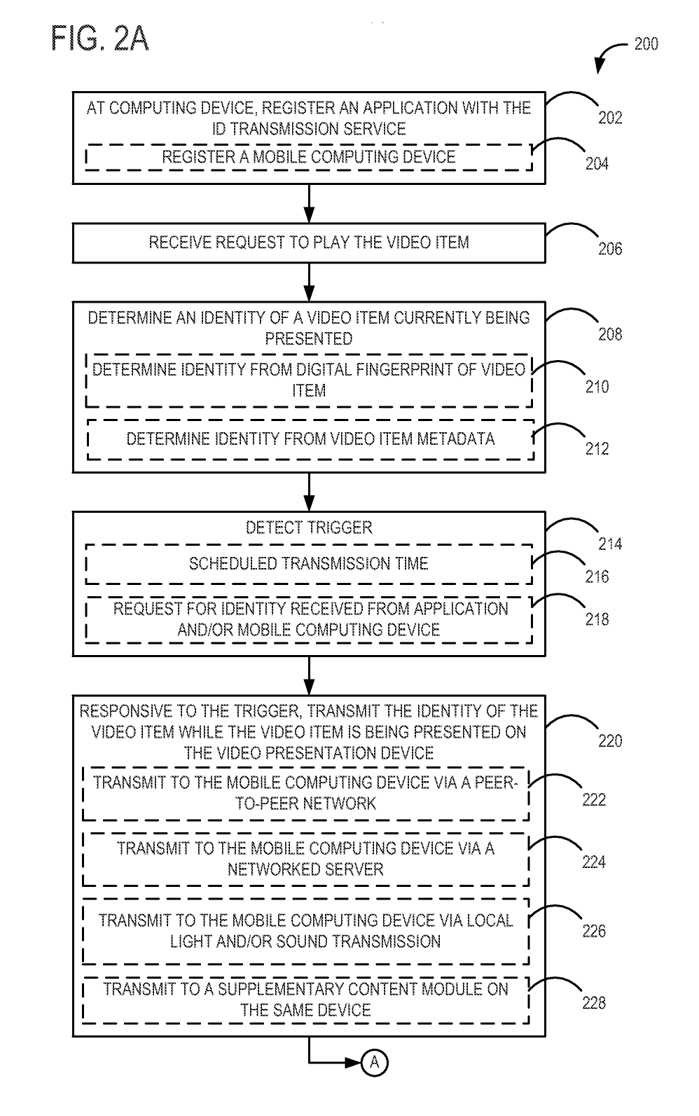

FIGS. 2A-B show a flow chart for an embodiment of a method 200 for distributing an identity of a video item being presented on a video presentation device within a video viewing environment to applications configured to perform a suitable software event based on an identity of the video item. For example, in some embodiments, the software event may obtain content related to the video item, while in other embodiments the software event may execute a software application on the user's primary or mobile device in responsive to receiving the video item's identity.

First, method 200 comprises, at 202, registering an application with an identity transmission service. The identity transmission service may act like a beacon, transmitting the identity of the video item to registered applications so that the applications may then obtain suitable related content. Further, such transmission may be repeated on a desired time interval so that mobile devices of later-joining viewers also may receive the identity information. The identity transmission service also may provide identity information when requested, instead of as a beacon.

Any suitable application may register with the identity transmission service. For example, some viewers may have a mobile computing device when watching another display device to access supplementary content about the video item being watched. Therefore, process 202 may comprise, at 204, registering a device on the mobile application with the identity transmission service. Likewise, in some cases, an application (e.g. a web browser) running on a same device used to present the primary video item may be used to obtain supplemental content. As such, process 202 may comprise registering an application on a same device as that used to present the primary video content. In another example, an application may be a digital rights management application configured to obtain digital rights to the video item from a digital rights clearinghouse based on the video item's identity, the related content including appropriate licenses for the video item.

At 206, method 200 includes receiving a request to play the video item. The request may be received from the registered application, or from any suitable device, without departing from the scope of the present disclosure.

Responsive to the request, the video content item is presented. Method 200 then includes, at 208, determining an identity of the video item currently being presented on the video presentation device. As used herein, the identity includes any information that may be used to identify the video item. For example, in some embodiments, 208 may include, at 210, determining the identity from a digital fingerprint of the video item. As described above, such a “fingerprint” of a video item may be identified based on patterns detected in one or more of a video signal and/or an audio signal for the video item, and therefore may be used even for video content items having no identification information, including but not limited to edited or derivative versions of a video content item in which identity information has been removed.

In one scenario, the identity may be determined from a digital fingerprint of the video item by collecting sound data from an audio signal included in an audio track for the video item and identifying the digital fingerprint based on the sound data. For example, referring to FIG. 1, an audio sensor included in video viewing environment sensor system 112 may collect sound data capturing a portion of an audio track of video item 102. Media computing device 106 may then send the sound recording to a service running on server 120 (or other suitable location), which may match the recorded fingerprint with digital fingerprint database 122 to identify the video item. Thus, a video item may be identified using the digital fingerprint even if the computing device is not connected to content that is able to identify itself, or if a video presentation service displaying the video item and the identity transmission service are not interoperable (for example, incompatible services provided by different entities). For example, a video item played back from a VHS tape or a DVD that is not configured to identify the video item may still be identified from a digital fingerprint for that video item.

In other embodiments, as indicated at 212, the identity may be determined from metadata that is included with the video content item. The metadata may specify any suitable information, including but not limited to a universal identifier (e.g. a unique code for a particular video item and/or a particular scene in a particular item) that may be directly used to identify relevant content, and/or used to look up the video item in a database to retrieve title and other relevant information, such as actors appearing in the item, directors and filming locations related to the item, trivia for the item, and so on Likewise, in some embodiments, the identifier may include text metadata that are human-readable and/or directly enterable in a search engine by a receiving application, and may include information including show name, series number, season number, episode number, episode name, and the like.

Identity metadata may be included with a video item upon creation (including the creation of a derivative version of the video item), and/or sent as supplemental content by a content provider or distributer, such as a digital content identifier sent by a cable or satellite television provider to a set-top box. Where stored during the initial creation of a video item or video item version, the metadata may have a propriety format or a more widely-used format. Likewise, where the metadata is provided as supplemental content by a content provider or distributer), the identity metadata may be transmitted continuously during transmission of the associated metadata, periodically, or in any other suitable manner.

Continuing with FIG. 2, at 214, method 200 includes detecting a trigger configured to trigger transmission of the video item identity to the application. For example, in embodiments where the supplemental content presentation application is running on mobile computing device, a user may set a preference regarding how identity transmission is triggered. As a more specific example, a user may specify a time interval on which transmission is triggered while the video item is being displayed, as indicated at 216, so that the identity is broadcast according to predetermined schedule. In such embodiments, a user may not need to request video identity information, as the secondary content presentation application may automatically retrieve secondary content upon receipt of the transmitted identity. Likewise, instead of automatically retrieving content, the application may check for available content (e.g. content provided by a same entity that provides the primary content), and alert a user as to any available content upon receipt of such triggers. Additionally or alternatively, in some embodiments, identity transmission may be triggered upon receipt of a request received from the application, as indicated at 218. This may occur, for example, when a user chooses to receive supplemental content notifications only when requested, rather than automatically. It will be appreciated that these specific triggering scenarios are presented for the purpose of example, and that any suitable trigger may be employed to trigger transmission of a video item identity.

Continuing with FIG. 2A, at 220, method 200 includes, responsive to the trigger, transmitting the identity of the video item while the video item is being presented on the video presentation device. By transmitting the video item identity to the application while the video item is being displayed to the viewer, the application may obtain contextually relevant supplementary content for presentation to the viewer during video content presentation, which may enhance the entertainment potential of the supplementary content and the video item. It will be understood that the identity transmitted may correspond to an identity of the video content item as a whole, to a scene within the video item, or to any other suitable portion of a video content item.

The video item identity may be transmitted in any suitable manner. For example, in some embodiments, the identity may be transmitted to the application via a peer-to-peer network connection at 222. In this case, referring to FIG. 1, mobile computing device 105 may receive identity information for video item 102 from media computing device 106 via local wireless network 126. Non-limiting examples of suitable peer-to-peer connections include local WiFi, Bluetooth and Wireless USB connections. It will be understood that the identity may be transmitted to more than one application in this manner, such as when two or more viewers each wish to receive supplemental content on mobile devices.

In other embodiments, the identity may be transmitted to one or more applications via a server computing device networked with the computing device and application, respectively. For example, mobile computing device 105 of FIG. 1 may receive identity information for video item 102 from media computing device 106 via server computing device 120 and network 124. Non-limiting examples of such network connections include wired and/or wireless LANs and WANs, ISP connections, and other suitable networks. In such embodiments, media computing device 106 may send the identity information directly to mobile computing device 105, or to a designated address at which mobile computing device may retrieve the information.

In yet other embodiments, the identity may be transmitted to the mobile computing device and/or the application at 226 via a local light and/or sound transmission. For example, an ultrasonic signal encoding the identity may be output by an audio presentation device into the video viewing environment, where it is received by an audio input device connected with a viewer's mobile computing device. It will be appreciated that any suitable sound frequency may be used to transmit the identity without departing from the scope of the present disclosure. Further, it will be appreciated that, in some embodiments, the identity may be transmitted to the mobile computing device via an optical communications channel. In one non-limiting example, a visible light encoding of the identity may be output by the video presentation device for receipt by an optical sensor connected with the mobile device during presentation in a manner that the encoded identity is not perceptible by a viewer Likewise, identity information may be transmitted via an infrared communication channel provided by an infrared beacon on a display device or media computing device.

In yet other embodiments, as indicated at 228, the identity may be transmitted to a supplementary content presentation module on the same computing device at 228. In other words, the identity may be detected at one module on a computing device where the video item is being presented and transmitted to a supplementary content module on the same computing device so that contextually-related content may be presented on the same computing device. In one specific embodiment, the identity transmission service may be implemented as an operating system component that automatically determines the identification of video content items being presented, and then provides the identifications to applications registered with the identity transmission service.

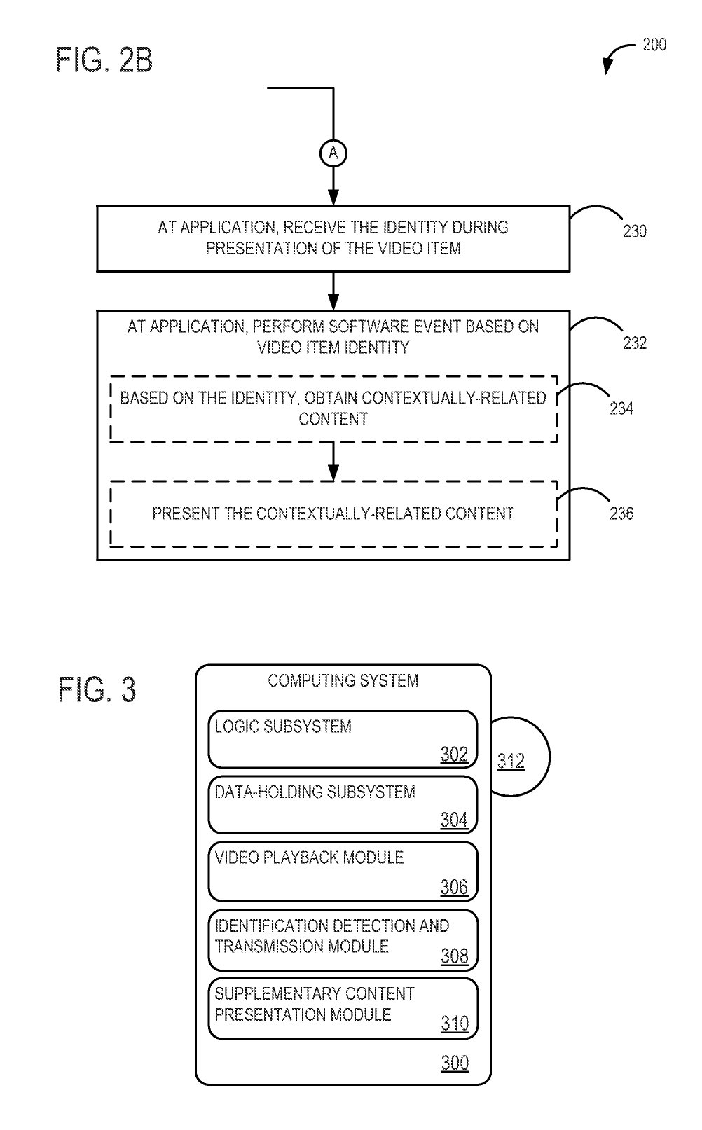

FIG. 3 shows a block diagram of a generic computing device that comprises an identity transmission service in the form of an identification detection and transmission module 308 of a computing device 300. Identification detection and transmission module 308 is configured to determine an identity of a video item being presented by a video playback module 306 running on the computing device based, for example, on a digital fingerprint of the video item and/or identity metadata, and to send determined identities to a supplementary content presentation module 310 residing within computing device 300. Having received the video item identity from digital fingerprint detection module 308, supplementary content module 310 may then obtain content contextually related to the video item based on the identity and then may output that content for presentation to a viewer.

The supplementary content module 310 may display the supplementary content in any suitable manner, including but not limited to in a different display region of a video presentation device on which the video item is being displayed, as a partially transparent overlay over the video item, etc. For example, sidecar links spawned by a web browser may be presented in a display region next to a display region where the video presentation module is displaying the video item.

The transmission examples provided above are not intended to be limiting, and it will be appreciated that combinations of computing devices running services from any suitable combination of service providers may be employed without departing from the scope of the present disclosure. For example, a user may have a cable service with a set-top-box provider and a web service with a separate online service provider. In such an instance, the user's mobile device may use an application programming interface (API) provided by the cable service (or any suitable API provider) to communicate with a set-top-box or other transmitting device and receive video item identities. Once identified, the mobile device may then obtain contextually-related supplemental content from the web.

Turning to FIG. 2B, method 200 includes, at 230, receiving at the application the identity of a video item during presentation of the video item on the video presentation device. The identity may identify an entirety of the video item, a particular scene in the video idem, or any other suitable portion of the video item.

At 232, method 200 includes performing a software event based on the video item identity. For example, as depicted in FIG. 2B, the software event may includes processes configured to obtain content that is contextually-related to the video item and then present that content to the user. Thus, in some embodiments, 232 may include, at 234, obtaining content contextually related to the video item based on the video item identity. Any suitable contextually-related content may be provided, including, but not limited to, web pages, advertisements, and additional video items (e.g., professionally-made featurettes, fan-made video clips and video mash-ups, and the like). In an example where a digital rights management application receives the video item identity, the application may receive a license for the video item. In an example where a search engine running on a web browser application receives a query related to the video item identity, one or more search results may be obtained that are related to the video item. In such an embodiment, once the contextually-related content has been obtained, it is presented to the viewer at 236. It will be appreciated that other suitable software events may be performed within process 232 and/or that one or more processes included within process 232 may be excluded without departing from the scope of the present disclosure.

It will be appreciated that the application may perform other tasks associated with obtaining the related content. For example, in some embodiments, the application may provide analytical data about the content the viewer received to an analytical service. As a more specific example, in the case of digital rights management applications, analytical data may be provided to a digital rights management service and used to track license compliance and manage royalty payments. Further, in the case of web services, page view analytics may be tracked and fed to advertisers to assist in tracking clickthrough rates on advertisements sent with the contextually related content. For example, tracking clickthrough rates as a function of scene-specific video item identity may help advertisers understand market segments comparatively better than approaches that are unconnected with video item identity information.

In some embodiments, the above described methods and processes may be tied to a computing system including one or more computers. In particular, the methods and processes described herein may be implemented as a computer application, computer service, computer API, computer library, and/or other computer program product.

FIG. 3 schematically shows a non-limiting computing system 300 that may perform one or more of the above described methods and processes. Computing system 300 is shown in simplified form. It is to be understood that virtually any computer architecture may be used without departing from the scope of this disclosure. In different embodiments, computing system 300 may take the form of a mainframe computer, server computer, desktop computer, laptop computer, tablet computer, home entertainment computer, network computing device, mobile computing device, mobile communication device, gaming device, etc. The arrangement and distribution of the modules shown in the embodiment depicted in FIG. 3 is not intended to be limiting; thus, it will be understood that the modules shown in FIG. 3 may be distributed among a plurality of computing devices without departing from the scope of the present disclosure.

Computing system 300 includes a logic subsystem 302 and a data-holding subsystem 304. Computing system 300 may optionally include a display subsystem, communication subsystem, and/or other components not shown in FIG. 3. Computing system 300 may also optionally include user input devices such as keyboards, mice, game controllers, cameras, microphones, and/or touch screens, for example.

Logic subsystem 302 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 302 may include one or more processors that are configured to execute software instructions. Additionally or alternatively, logic subsystem 302 may include one or more hardware or firmware logic machines configured to execute hardware or firmware instructions. Processors of logic subsystem 302 may be single core or multicore, and the programs executed thereon may be configured for parallel or distributed processing. Logic subsystem 302 may optionally include individual components that are distributed throughout two or more devices, which may be remotely located and/or configured for coordinated processing. One or more aspects of logic subsystem 302 may be virtualized and executed by remotely accessible networked computing devices configured in a cloud computing configuration.

Data-holding subsystem 304 may include one or more physical, non-transitory devices configured to hold data and/or instructions executable by logic subsystem 302 to implement the herein described methods and processes. When such methods and processes are implemented, the state of data-holding subsystem 304 may be transformed (e.g., to hold different data).

Data-holding subsystem 304 may include removable media and/or built-in devices. Data-holding subsystem 304 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 304 may include devices with one or more of the following characteristics: volatile, nonvolatile, dynamic, static, read/write, read-only, random access, sequential access, location addressable, file addressable, and content addressable. In some embodiments, logic subsystem 302 and data-holding subsystem 304 may be integrated into one or more common devices, such as an application specific integrated circuit or a system on a chip.

FIG. 3 also shows an aspect of data-holding subsystem 304 in the form of removable and/or non-removable computer storage media 312, which may be used to store and/or transfer data and/or instructions executable to implement the herein described methods and processes. Computer storage media 312 may take the form of CDs, DVDs, HD-DVDs, Blu-Ray Discs, EEPROMs, and/or floppy disks, among others.

It is to be appreciated that data-holding subsystem 304 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 300 that is implemented to perform one or more particular functions. In some cases, such a module, program, or engine may be instantiated via logic subsystem 302 executing instructions held by data-holding subsystem 304. It is to be understood that different modules, programs, and/or engines may be instantiated from the same application, service, code block, object, library, routine, API, function, etc Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, a display subsystem may be used to present a visual representation of data held by data-holding subsystem 304. As the herein described methods and processes change the data held by data-holding subsystem 304, and thus transform the state of data-holding subsystem 304, the state of the display subsystem may likewise be transformed to visually represent changes in the underlying data. A display subsystem may include one or more display devices utilizing virtually any type of technology. Such display devices may be combined with logic subsystem 302 and/or data-holding subsystem 304 in a shared enclosure, or such display devices may be peripheral display devices.

When included, a communication subsystem may be configured to communicatively couple computing system 300 with one or more other computing devices. A communication subsystem may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow computing system 300 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. At a computing device, a method of distributing an identity of a video item being presented on a video presentation device within a video viewing environment to one or more applications configured to obtain content related to the video item, the method comprising:
determining an identity of the video item currently being presented on the video presentation device; and
responsive to a trigger, transmitting to a receiving application the identity of the video item while the video item is being presented on the video presentation device.

2. The method of claim 1, wherein the trigger includes one or more scheduled transmission times for the identity while the video item is being displayed.

3. The method of claim 1, wherein determining the identity of the video item includes determining the identity from a digital fingerprint of the video item.

4. The method of claim 3, wherein determining the identity from the digital fingerprint of the video item includes:
collecting sound data from an audio track for the video item; and
identifying the digital fingerprint based on the sound data.

5. The method of claim 3, wherein determining the identity from the digital fingerprint of the video item includes, at a detection identification detection and transmission module of the computing device, identifying the digital fingerprint, and wherein transmitting the identity includes transmitting the identity from the digital fingerprint detection module to a supplementary content module of the computing device, and the method further comprising, at the supplementary content module, receiving the identity and obtaining content contextually related to the video item based on the identity.

6. The method of claim 1, further comprising registering the receiving application on a mobile computing device with the computing device.

7. The method of claim 6, wherein the trigger includes a request for the identity received from the receiving application on the mobile computing device.

8. The method of claim 6, wherein transmitting the identity includes transmitting the identity to the receiving application on the mobile computing device via a peer-to-peer network connection.

9. The method of claim 6, wherein transmitting the identity includes transmitting the identity to the receiving application on the mobile computing device via a server computing device networked with the computing device and the mobile computing device.

10. The method of claim 6, wherein transmitting the identity includes transmitting the identity to the receiving application on the mobile computing device via a sound transmission generated by an audio presentation device connected with the computing device.

11. A mobile computing device configured to identify a video item displayed via another video presentation device and obtain content related to the video item for display on the mobile computing device in a common viewing environment with the other video presentation device, the mobile computing device comprising:
a data-holding subsystem holding instructions executable by a logic subsystem, the instructions configured to:
receive an identity for a video item during presentation of the video item on the other video presentation device;
based on the identity, obtain content contextually related to the video item; and
present the content contextually related to the video item.

12. The device of claim 11, wherein the instructions to receive the identity include instructions to receive the identity via a peer-to-peer connection.

13. The device of claim 11, wherein the instructions to receive the identity include instructions to receive the identity via a network connection from a server.

14. The device of claim 11, wherein the instructions to receive the identity includes receiving the identity by a sound transmission received via an audio input connected with the mobile computing device.

15. The device of claim 11, further comprising instructions to register the mobile computing device with another computing device in the video viewing environment from which the identity is received.

16. The method of claim 15, further comprising instructions to send a request for the identity to the other computing device.

17. A media presentation system configured to provide alerts of an identity of a video item being presented within a video viewing environment to applications configured to obtain content related to the video item, the system comprising:
an audio input configured to receive sound data from an audio input device;
an audio output configured to output audio data to an audio presentation device;
a display output configured to output video item to a display device;
a logic subsystem; and
a data-holding subsystem holding instructions executable by the logic subsystem to:
collect sound data from the audio input device capturing a portion of an audio track of the video item;
based on the sound data, identify the video item; and
responsive to a trigger, transmit an identity for the video item for receipt by a receiving application running in the viewing environment.

18. The system of claim 17, further comprising instructions to register a mobile computing device running the receiving application with the media presentation system.

19. The system of claim 18, wherein the trigger includes a request for the identity received from the mobile computing device.

20. The system of claim 19, wherein the instructions to transmit the video item identity include instructions to transmit the identity via one of a peer-to-peer network connection, a network connection via a server, and a sound transmission output by the audio output.
